(19) United States
(12) Patent Application Publication
(10) Pub. No.: US 2008/0190715 A1
(43) Pub. Date: Aug. 14, 2008

(54) Disc Brake

(76) Inventor: Seoungil Kang, Poughkeepsie, NY (US)

Correspondence Address: SEOUNGIL KANG, 16 BRIAN COURT, POUGHKEEPSIE, NY, 12603, US

(21) Appl. No.: 11/672,732

(22) Filed: Feb. 8, 2007

(51) Int. Cl. F16D 55/225

(52) U.S. Cl. 188/73.1; 188/73.38

(57) ABSTRACT

This invention is about disc brake for an automobile installed in a carrier. The disc brake has a special feature which reduces temperature and noise in the automobile when braking. The special feature is a coated pad spring.

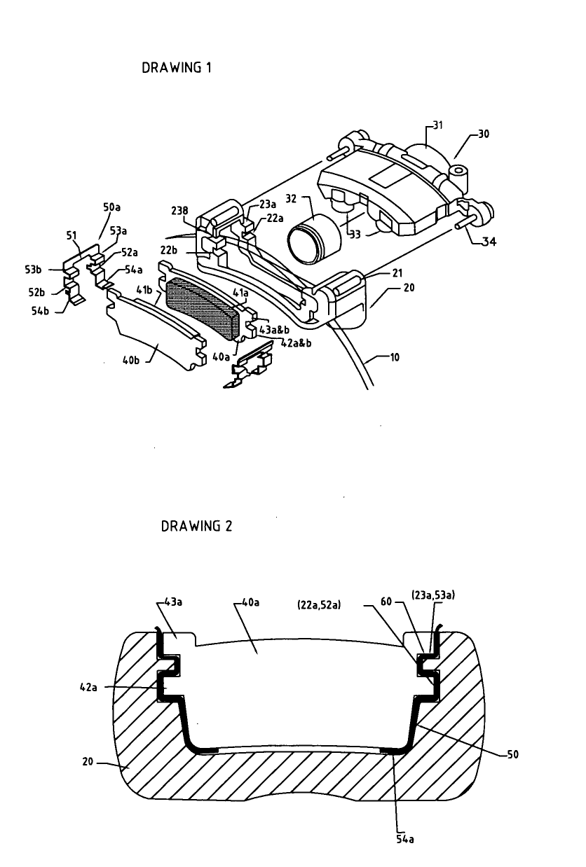

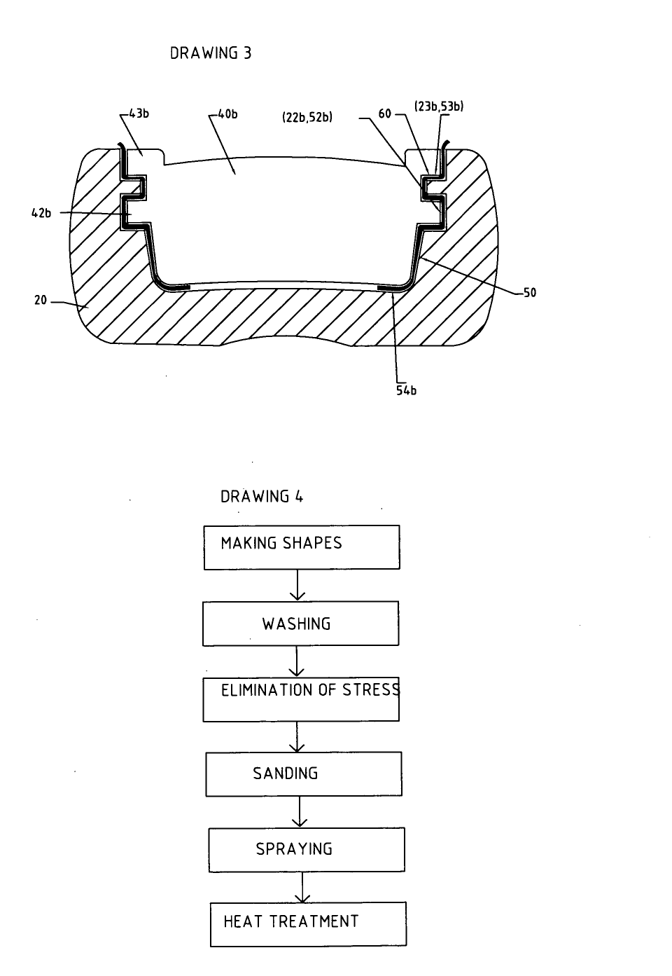

### SUMMARY

The invention is regarding a Disc brake, whose purpose is to provide a disc brake reducing the sound of friction and vibration of a pad spring, which is supporting a pad plate, through refurbishment of the pad spring.

As for the invention of a disc brake, the disc brake will be installed in the carrier (20) and serves to reduce the sound of friction between a pad plate (40a, 40b) and a pad spring (50) with coating a low friction material such as Teflon in the pad spring (50), which serves supporting the pad plate (40a, 40b).

Consequently, the pad plate (40a, 40b) can move into the carrier (20) smoothly and freely and also reduce the sound of friction.

### DETAILED STATEMENT

### Simple Explanations on Drawings

Drawing 1 is regarding a slightly slanting drawing on a disc brake for vehicle based on the invention.

Drawing 2 is regarding a sectioned drawing which illustrates a low friction material in a side of a pad spring of a disc brake for vehicle based on the invention.

Drawing 3 is regarding a sectioned drawing which illustrates a low friction material in both sides of a pad spring of a disc brake for vehicle based on the invention.

Drawing 4 is regarding a drawing on flow, which illustrates the process of coatings of Teflon and a low friction material in the pad spring of a disc brake for vehicle based on the invention.

* Explanations of codes on main parts of Drawing
10: Disc, 20: Carrier, 22a, 22b: First Installment Part,
23a, 23b: Second Installment Part
30: Caliper Housing, 40a, 40b: Pad Plate
42a, 42b: Protrusion of First Installation, 43a, 43b: Protrusion of Second Installation
50: Pad Spring, 52a, 52b: First Supporting Part
53a, 53b: Second Supporting Part, 54a, 55b: Spring Support Part
60: Low friction material

### DETAILS OF THE INVENTION

### The Objective of the Invention

### <Technology Belongs to the Invention and Conventional Technology in the Area>

The invention is regarding a disc brake and is, in particular, regarding a pad spring.

Generally, a disc brake for vehicle is a device for maintaining the reduction of speed, a stop, and a standstill of a moving vehicle and the device gains a braking power by a strong pressure of both pads with a disc spinning along with wheels.

Previous disc brakes were installed a caliper housing, which has a piston moving back and forth by a braking oil pressure and also installed a couple of pad plates. Previous disc brakes are equipped with a carrier, which is fixed in the car body, and a disc spinning with wheels.

A piston is installed in the rear of the caliper housing, which moves back and forth by a braking oil pressure and the piston functions pushing one pad plate and a finger part is installed in the front of the caliper housing, which functions pushing the other pad plate toward a disc.

Carrier is installed via knuckle bolts in the car body and two pad plates is installed in the inner parts, which is possible sliding and a pad spring is installed, which serves a lever and a guide the movements of pad plates between pad plates and a carrier.

Accordingly, when a driver put on the brake, a piston and a finger part push the pad plates by a braking oil pressure generated from a master cylinder and both pad plates press a disc again and in turn, the vehicle is being put on the brake.

Previous disc brakes, however, has a problem, which is a noise generated from frictions. The reason why both pad plates and a pad spring are comprised of metals, which is contacted the pad spring directly when pad plates move back and forth.

In addition, there were dusts due to the abrasion both pad plates and a disc by repeated braking movements, which raise a problem such as vibrations in movements of pad plates since these dusts are sticking the pad spring.

<Technical Problems will be Solved via the Invention>

The invention is to solve the above mentioned problems and the genuine objective of the invention is to provide a disc brake reducing the noise generated from frictions and vibrations through improvements of a pad spring supporting pad plate possible movements.

### <The Composition and Features of the Invention>

To achieve above stated objective, the invention includes the following features.

In terms of the pad spring, a couple of pad plates will be installed the inner part, which has each attached pad to exert a braking power fully rubbing both side of the disc. The pad plates contain a low friction material in the adjoining the pad plates to move the pad plates smoothly.

On top of that, one side is formed with a sunken installment part either a carrier or pad palates and the other side are formed with a protrusion of installment part corresponding with an installment part. Pad spring is equipped with supporting part corresponding with a protrusion of installment part in order to support the protrusion of installment part.

The low friction material is installed at least either the supporting part or adjoining part of supporting part.

The pad spring is equipped with a low friction material supporting the lower part of the pad plates smoothly.

In addition, the pad spring is equipped with a low friction material boarding on the carrier to perform the damping function between the carrier and the pad plates.

As shown the drawing 1 and drawing 2, the disc brake of the invention is a device, which gains a braking power by a friction between pad plates (40a, 40b) attached a friction pad (41a, 41b) and a disc (10) and the device is equipped with a carrier installed in the car body and a caliper housing (30), which is combined with the carrier making it possible to slide.

A cylinder part (31) is installed on the one side of the caliper housing (30), which moves back and forth in accordance with a oil pressure supplied from the source of oil pressure such as master cylinder within the cylinder (31) and one side of the pad plate (40a) could be installed a piston pressing the disc (10). The other side of the caliper housing (30) is installed a finger part (33), which could press the other side of the pad plate (40b) along with sliding movements of the caliper housing (30).

Each guide rod is installed at both ends of the caliper housing (30), which is combined with carrier (20) in a sliding form and each sling hall (21) is installed at both ends of the carrier in corresponding with guide rods (34).

As for these disc brakes for vehicles, the first installation part is formed in a sunken manner in order to install the pad plates (40a, 40b) at both ends of the carrier (20) inside part. The first installment part (22a, 22b) is formed in a corresponding manner at both ends of the carrier (20) inside part and the pad plates (40a, 40b) are formed side by side at both ends of the carrier.

The first protrusion of installation (42a, 42b) at both ends of the carrier is formed to insert the pad plates into the first installment part (22a, 22b) of the carrier (20).

In case of Pad plates (40a, 40b), the second protrusion of installment part (43a, 43b) is formed at a some distance from the first protrusion of installment part (42a, 42b) and the second installment part (22a, 23a) is formed in the carrier (20) to support the second protrusion installment (43a, 43b).

Pad spring (50) is installed between the first installment part (22a, 22b) and the first protrusion installment (42a, 42b) and between the second installment part (22a, 23a) and the second protrusion of installment (43a, 43B), which serves supporting the pad plates (40a, 40b) possible moving into the carrier (20).

Pad spring (50) is equipped with the first supporting part (52a, 52b), which is inserted into the first installment part (22a, 22b) to support the first protrusion of installment (42a, 42b) and the second supporting part 53a, 53b), which is formed in the second installment part (23a, 23b) to support the second protrusion of installment part (43a, 43b).

Also, Pad spring (50) is equipped with connection part (51), which is connected at each end of the second supporting part (53a, 53b) in a extended form, and spring support part (54a, 54b), which serves as a support the lower part of the pad plates (40a, 40b).

Pad spring (50) is coated with a low friction material (60) such as Teflon at the first supporting part (52a, 52b), the second supporting part (52a, 52b), spring support part (54a, 54b), and adjoining parts between the first supporting part (52a, 52b) and the second supporting part (52a, 52b), which reduces the friction between the pad plates (40a, 40b) and the pad spring (50). And the low friction material (60) is formed all contacting parts of pad spring (50) with pad plates (40a, 40b) directly not limiting above stated parts.

Although it is not presented on the drawing, rattle prevention spring is set up to prevent rattling noise at the top of pad plate (40a, 40b). Plate (40a, 40b) is moved smoothly through the low frictional matter coated on pad spring (50), it is became possible to fix the preventing rattle spring (50) closely to pad plate (40a, 40b), so it is became possible to prevent rattle noise effectively.

Refer to drawing 3, not only the side face pad plate (40a, 40b) but the side face carrier (20) of pad spring (50) is coated with the low frictional matter (60), so it is became possible to perform damping function between pad plate (40a, 40b) and carrier (20), and so noise is relieved.

Refer to drawing 4, follows is explanation about producing process of pad spring (50) coated with Teflon and the low frictional matter (60).

Treat metallic material by pressing or forming and produce with shape of pad spring (50) and clean that, and treat that by annealing of 400° c. to remove stress.

After this treat that by sand blast of fixed pressure with Sand to it is kept external intensity of illumination up, 3˜5 μm, jet Teflon and the low frictional matter (60) to pad spring (50).

Finally, treat that by heating of 350° c. for 15 minutes, coating process is completed.

Unlike the above statement, producing process of pad spring (50), it makes no difference to make the shape of pad spring (50) after treating metallic material by Teflon coating.

The following is explanation about braking function and effect of Disk Brakes made in accordance with this invention.

Driver hit the brake when he drives car, braking oil pressure is formed on master cylinder and that is delivered to caliper housing (30).

Under the influence of braking oil pressure piston of cylinder part located on side of caliper housing (30) push pad plate (40a) and applies pressure to disk (10), and under the influence of braking oil pressure caliper housing (30) decamps, so finger part (33) located on other side of caliper housing (30) push other side of pad plate (40b) and applies pressure to disk (10). So that, two friction pads (41a, 41b) attached on two pad plates (40a, 40b) applies pressure to disk (10), friction between frictional pads (41a, 41b) and pad disk (10) makes braking, the low frictional matter (60) coated on pad spring (50) reduces friction between pad spring (50) and pad plates (40a, 40b), as a result pad plates (40a, 40b) moves smoothly in carrier (20) and frictional noise is decreased.

And the driver take off the brake, braking oil pressure is released, frictional power (Residual Drag) between disk (10) revolving with wheel and pads (41a, 41b) widen the space between two pad plates (40a, 40b) and disk (10), in this case the low frictional matter (60) coated on pad spring (50) reduces the friction between pad spring (50) and pad plates (40a, 40b), so pad plates (40a, 40b) returns smoothly and frictional nose is decreased.

### Effect of the Invention

As the above statements, according to Disk Brakes followed this invention, the low frictional matter coated on pad spring reduces friction with pad plate, so the pad plate moves smoothly.

Accordingly, frictional noise is decreased, it is possible to fix preventing rattle spring closely to pad plate and prevent rattle noise effectively.

And braking action repeated makes wear of pad plate and disk, it makes minute dusts, the dusts is not stick to pad spring coated with the low frictional matter, it is possible to prevent minute shake occurred when pad plate moves.

And in case of the low frictional matter coated on two sides of pad spring, it performs damping function between pad plate and carrier, noise is decreased.

1. This is a Disk brake for the cars which has a pair of pad plate installed inside in order to show breaking power by producing friction with the above disk and the disk that is revolving with the wheel. This includes the carrier installed inside the car body, and a pad spring which supports the above mentioned pad plate to enable this to move to the carrier, also this pad spring has a low friction material prepared at where it adjoins with the pad plate for smooth movement.

2. In terms of article no. 1, there is a concavely formed installment part arranged either in the above carrier or in the pad plate, and the other part has a protrusion of installation which combines with the above installment part. Another special feature for this Disk brake is that it has a supporting part to support the protrusion of installation in a form that corresponds with it.

3. In terms of article no. 2, this Disk brake specially has a low friction material at least in one place either in the above supporting part or in its adjacent area.

4. In terms of article no. 1, the above pad spring of this Disk brake has an elastic support parts with low friction material installed, which supports the bottom part of the above pad plate with elasticity.

5. In terms of article no. 1, a low friction material is installed for this Disk break in the area where the above pad spring and the carrier meets together, in order to assist the damping function between the above carrier and the pad plate.

6. In terms of article no. 1, above low friction material installed in this Disk brake is made out of Teflon.
